(19) United States
(12) Patent Application Publication
(10) Pub. No.: US 2010/0203197 A1
(43) Pub. Date: Aug. 12, 2010

(54) Sports Drink Acid Blend To Reduce Or Eliminate Aftertaste

(75) Inventors: Rod Jendrysik, Sycamore, IL (US); MaryKay Skrypec, Buffalo Grove, IL (US); Stacey M. Kappes, Champaign, IL (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: STOKELY-VAN CAMP, INC., Chicago, IL (US)

(21) Appl. No.: 12/766,998

(22) Filed: Apr. 26, 2010

Related U.S. Application Data
(63) Continuation of application No. 11/169,358, filed on Jun. 29, 2005.

(51) Int. Cl. A23L 2/52; A23L 2/38

(52) U.S. Cl. 426/74; 426/590

(57) ABSTRACT

An improved sports beverage containing an acidulant system that results in a sports beverage with reduced total aftertaste and an increase in the pleasantness of the aftertaste as well as significantly higher gulpability compared to conventional sports beverages. The acidulant system is composed of citric and phosphoric acid in specific relative amounts.

### FIELD OF THE INVENTION

The present invention relates to an improved sports beverage which provides for fluid, carbohydrate and electrolyte replacement. The beverage comprised of a novel acidulant blend substantially reduces the level of aftertaste of typical sports beverages and increases significantly the gulpability of such sports drinks.

### BACKGROUND OF THE INVENTION

Sports beverages provide important benefits to athletes such as rehydrating the body and replenishing lost electrolytes and carbohydrates after performing physical activities. Such sports beverages typically are non-carbonated. Even though these sports beverages provide great benefits to athletes, sometimes they are not consumed in adequate quantities to achieve these benefits. Such sports beverages have what some consumers deem to be an excessive level of aftertaste. In addition, research has shown that athletes experience taste burnout due to the level of aftertaste typical of sports beverages.

A need exists for a sports beverage, particularly a non-carbonated sports beverage, that has either no or at least a substantially reduced aftertaste. Another object of the present invention is to improve the “chuggability” or “gulpability” of sports beverages, i.e., including the tendency of the user to drink the beverage relatively rapidly when thirsty.

### SUMMARY OF THE INVENTION

In accordance with one aspect of the present invention, a non-carbonated sports beverage composition is provided that at least substantially reduces the level of aftertaste and provides a more pleasant aftertaste. The non-carbonated sports beverage composition typically comprises water, electrolytes, a material selected from carbohydrates, non-nutritive sweeteners and combinations thereof, one or more flavoring agents, and a novel acidulant. The novel acidulant comprises citric acid in an amount from about 0.10% to about 0.15% by weight of the non-carbonated sports beverage composition and phosphoric acid, wherein the ratio of citric acid to phosphoric acid is from about 3.5:1 to about 4.2:1 and wherein the non-carbonated sports beverage composition has a pH from about 2.5 to about 4.5 and more specifically about 2.7 to 3.3.

Unexpectedly, the novel acidulant in accordance with the present invention significantly reduces the level of aftertaste of sports beverages and also provides a more pleasant aftertaste. Further, it was unexpectedly found that the combination of the citric acid and the phosphoric acid in the ratio used in the present invention is effective in stimulating the desire to consume the inventive beverages. As a result and to the surprise of the inventors, athletes more readily “chug,” “gulp” or drink relatively rapidly the non-carbonated sports beverage of the present invention as compared to conventional sports beverages. Conventional sports beverages typically contain only citric acid as the acidulant.

In accordance with another aspect of the present invention, a method for making a non-carbonated sports beverage composition that has a reduced level of aftertaste is provided. The method comprises the steps of: adding citric acid in an amount from about 0.10% to about 0.15% by weight of said non-carbonated sports beverage composition, adding phosphoric acid wherein the weight ratio of citric acid to phosphoric acid is from about 0.5:1 to about 13.8:1, and wherein said sports beverage has a pH from about 2.5 to about 4.0.

A beverage in accordance with the invention may also include protein in an amount as desired.

### DETAILED DESCRIPTION OF THE INVENTION

In accordance with the present invention, a non-carbonated sports beverage composition having a reduced level of aftertaste compared to conventional sports beverages is provided. The beverage in accordance with the invention may also have a more pleasant aftertaste. Typical non-carbonated sports beverage compositions in accordance with the invention comprise water, electrolytes, carbohydrate, one or more flavoring agents, optionally one or more sweetening agents, one or more color agents and citric acid and phosphoric acid in a suitable ratio and amount. Typically, the pH of the sports beverage will be in the range of from about 2.5 to about 4.0. The amounts of water, electrolytes, carbohydrates, flavoring agents and sweetener can be as desired. These are well-known components of sports beverages. The inventive citric/phosphoric acid combination in the specified amounts and ratios provides the recited advantages even in the absence of a flavor component or agent.

An unexpected result of the present invention is the significant reduction in the level of aftertaste and providing a more pleasant aftertaste. Another unexpected result of the present invention is the effective increase in gulpability by the novel combination of the citric acid and the phosphoric acid in the ratio used in the present invention as well as a more pleasant aftertaste. Surprisingly, athletes “chugged” the non-carbonated sports beverage of the present invention as compared to other sports beverages. The combination of phosphoric acid and citric acid in the recited amounts and ratios provides a cleaner tasting sports beverage with minimal to no aftertaste, despite the presence of sports beverage electrolytes.

The terms “chug,” “chugged,” “chuggability,” “gulpability,” “gulpable” and variations thereof as used herein mean the drinking of a beverage in gulps or to drink relatively hurriedly or quickly.

While not wishing to be bound by theory, it is believed that the novel acid components amount and specific weight ratio of the acid in a sports beverage result in these unexpected and highly desirable properties. In accordance with another aspect of the present invention, the citric acid of the present invention is anhydrous citric acid. The amount of citric acid preferably comprises from about 0.10% to about 0.15% by weight of the non-carbonated sports beverage, and most preferably in the range from about 0.12% to about 0.13% by weight of the non-carbonated sports beverage.

In accordance with another aspect of the present invention, the phosphoric acid used in the present invention may be phosphoric acid at 75% strength. The weight ratio of citric acid to phosphoric acid typically comprises from about 0.5:1 to about 13.8:1, and most preferably in the range from about 5.0:1 to about 5.2:1.

In accordance with still another aspect of the present invention, a flavoring agent optionally may be used in a beverage in accordance with the present invention. The flavoring agent of the beverage of the present invention also impacts the overall acceptance of the beverage. In order to achieve this overall acceptance, the strength of the flavor cannot be too intense. Of course, the flavor intensity of the beverage will depend upon the amount and type of the particular flavoring agent used. Furthermore, the same flavor from different suppliers may have differing intensity. Thus, it is difficult to quantify the level of flavoring agent necessary for the present invention. In addition, any flavoring agent or agents which satisfy the above criteria and are known to be useful to those skilled in the art can be used in the present invention. Non-limiting examples of particularly useful flavoring agents include but are not limited to, lemon-lime, orange, fruit punch, lime, cherry, berry and tangerine.

Any suitable carbohydrate can be used and typically the carbohydrate present in the sports beverage may be mono-, di- and higher saccharides, such as, for example, glucose (dextrose), sucrose, maltodextrin, maltose, fructose and trehalose. Various combinations of sweeteners may be used as desired, such as: fructose and glucose; fructose and sucrose; fructose, glucose and sucrose; and sucrose and dextrose, for example. Typically, the carbohydrates in a sports beverage will be present in an amount of from about 4% to about 10% by weight of the total sports beverage. In another embodiment of the invention, a non-nutritive sweetener or sweeteners can be substituted in whole or in part for tea carbohydrate. Any suitable non-nutritive sweetener, whether natural or synthetic, can be used.

Typical sports beverages in accordance with the invention will include electrolytes as desired. Generally, the electrolytes comprise potassium, sodium and chloride ions and optionally calcium and magnesium ions and are supplied as desired, as is well known to those skilled in the art. The source of the electrolytes may be, for example, sodium chloride, potassium chloride, monopotassium phosphate, sodium citrate, calcium lactate and magnesium oxide. Typical electrolytes for a sports beverage and amounts are, when present, generally in the range of: sodium—about 10 to about 75 mEq/liter (more typically at least about 45 mEq/liter); potassium—about 3 to about 20 mEq/liter; chloride—about 9 to about 25 mEq/liter; calcium—about 0.5 to about 15 mEq/liter; and magnesium—about 0.5 to about 15 mEq/liter.

In addition, protein may be present in a beverage in accordance with the invention in an amount as desired. Typically, protein will be present in an amount of from 0 to about 30 grams/liter of beverage and more typically, when present, in an amount of from about 5 grams/liter to about 30 grams/liter of beverage or on a weight to volume basis from about 0.5% to about 3% by weight protein to volume of beverage. Any suitable protein source can be used as is known in the art, including for example, whey protein isolate, casein protein isolate, milk, protein isolate, protein peptides, protein hydrolysates, rice protein, wheat protein, soy protein, soy protein peptides, egg protein. Amino acid may be present in ranges as follows: about 2.5 grams/liter to about 15 grams/liter or about 0.25% to about 1.5% on a weight of amino acid to volume of beverage. Suitable amino acids are: leucine, valine, isoleucine, glutamine, arginine, tyrosine, alanine, cystine, histidine, threonine, lysine, phenylalanine and methionine.

One goal of a sports beverage is for electrolyte replacement in the human body. Consequently, the sports beverage may be isotonic or approximately isotonic, that is, the osmolality of the sports beverage can be the same or about the same as the osmolality of human blood. Typical osmolality will be in range of from about 250 mOsm/kg to about 400 mOsm/kg and more particular 280 mOsm/kg to about 340 mOsm/kg.

In accordance with another aspect of the present invention, a coloring agent may be used in the beverage of the present invention. Any coloring agent that is known to be useful to those skilled in the art can be used.

The present invention is further illustrated, but not limited by, the following example.

A beverage in accordance with the invention may also include other components as desired, including a clouding agent, typically at a concentration of from about 0 to about 100 ppm based on the total sports beverage. Examples of clouding agents include but are not limited to ester gum, SAIB, starch components and mixtures thereof. For example, ester gum may be present at a concentration of from about 10 to about 50 ppm and more specifically from about 15 to about 35 ppm. Other components that can be present in a sports beverage include vitamins and minerals, for example.

### EXAMPLE

To a gallon of unacidified lemon-lime Gatorade® base is added on a total weight basis of the resulting beverage:

phosphoric acid solution (75% by weight) 0.0324 wt % (0.0243 actual based on a 75% by weight solution),
citric acid 0.126 wt %,
   about a 5.2:1 weight ratio of citric acid to phosphoric acid in absolute quantities, and the resulting solution was stirred until complete and uniform mixing was achieved. The resulting sports beverage had a very clean taste with minimal aftertaste.

While the invention has been described with respect to certain preferred embodiments, as will be appreciated by those skilled in the art, it is to be understood that the invention is capable of numerous changes, modifications and rearrangements and such changes, modifications and rearrangements are intended to be covered by the following claims.

1. A non-carbonated sports beverage comprising: water; electrolytes, a material selected from the group consisting of carbohydrates and non-nutritive sweeteners; an acidulant system comprising citric acid in an amount from about 0.10% to about 0.15% by weight of said non-carbonated sports beverage composition and phosphoric acid, wherein the weight ratio of citric acid to phosphoric acid is from about 0.5:1 to about 13.8:1 and wherein said non-carbonated sports beverage composition has a pH from about 2.5 to about 4.0.

2. The non-carbonated sports beverage of claim 1 wherein the acidulant system comprises from about 0.12% to about 0.13% citric acid by weight of said non-carbonated sports beverage composition, wherein the ratio of citric acid to phosphoric acid is from about 5.0:1 to about 5.2:1 and wherein said non-carbonated sports beverage composition has a pH from about 2.7 to about 3.3.

3. The non-carbonated sports beverage of claim 1 wherein the electrolytes comprise sodium, potassium, calcium, magnesium and chloride ions.

4. The non-carbonated sports beverage of claim 3 wherein the sports beverage is approximately isotonic.

5. The non-carbonated sports beverage of claim 1 further comprising at least one flavoring agent.

6. The non-carbonated sports beverage of claim 1 further comprising protein.

7. The non-carbonated sports beverage of claim 1 wherein said sweetener is selected from the group consisting of sucrose, dextrose, maltose, maltodextrin, fructose and combinations thereof.

8. The non-carbonated sports beverage of claim 1 wherein the material is a non-nutritive sweetener.

9. The non-carbonated sports beverage of claim 1 comprising about 4% to about 10% carbohydrate by weight of the total sports beverage composition.

10. The non-carbonated sports beverage of claim 1 wherein the ratio of citric acid to phosphoric acid is about 3.9 to 1.

11. A non-carbonated sports beverage comprising water, sodium and potassium ions, at least one flavoring agent, a material selected from the group consisting of carbohydrates and non-nutritive sweetener, and an acidulant system comprising citric acid in an amount from about 0.10% to about 0.15% by weight of said non-carbonated sports beverage composition and phosphoric acid, wherein the weight ratio of citric acid to phosphoric acid is from about 0.5:1 to about 13.8:1 and wherein said non-carbonated sports beverage composition has a pH from about 2.5 to about 4.0.

12. The non-carbonated sports beverage of claim 11 wherein the pH of the beverage is in the range of from about 2.7 to 3.3.

13. The non-carbonated sports beverage of claim 11 further comprising protein.

14. The non-carbonated sports beverage of claim 10 wherein the non-carbonated sports beverage is approximately isotonic.

15. The non-carbonated sports beverage of claim 11 wherein the weight ratio of citric acid to phosphoric acid is about 5.2 to 1.

16. The non-carbonated sports beverage of claim 11 wherein said sweetener is selected from sucrose, dextrose, maltose, maltodextrin, fructose and combinations thereof.

17. The non-carbonated sports beverage of claim 11 wherein said sweetener comprises a non-nutritive sweetener.

18. A method of preparing a non-carbonated sports beverage composed of base components including water, electrolytes and carbohydrate that has a reduced level of aftertaste compared to conventional sports beverages comprising: combining the base components with an acidulant system by adding citric acid in an amount from about 0.10% to about 0.15% by weight of said non-carbonated sports beverage composition; adding phosphoric acid wherein the weight ratio of citric acid to phosphoric acid is from about 0.5:1 to about 13.8:1; and wherein said sports beverage has a pH from about 2.5 to about 4.0.

19. The method of claim 18 wherein the amount of said citric acid is from about 0.12% to about 0.13% by weight of said non-carbonated sports beverage composition; wherein the weight ratio of citric acid to phosphoric acid is from about 5.0:1 to about 5.2:1; and wherein said sports beverage has a pH from about 2.7 to about 3.3.

20. The method of claim 18 comprising adding citric and phosphoric acid to the base components to provide a weight ratio of citric acid to phosphoric acid of about 5.2 to 1.
